(19) United States
(12) Patent Application Publication
(10) Pub. No.: US 2012/0169315 A1
(43) Pub. Date: Jul. 5, 2012

(54) POWER SUPPLIES AND CONTROL METHODS FOR OPERATING IN QUADRATURE-RESONANCE-SIMILAR MODE

(75) Inventors: Chien-Liang Lin, Keelung City (TW); Chih-Hsueh Hsu, Keelung City (TW)

(73) Assignee: SHAMROCK MICRO DEVICES CORP., Taipei (TW)

(21) Appl. No.: 13/152,245

(22) Filed: Jun. 2, 2011

Related U.S. Application Data
(60) Provisional application No. 61/429,188, filed on Jan. 3, 2011.

(51) Int. Cl. G05F 1/618

(52) U.S. Cl. 323/283

(57) ABSTRACT

Control method and power controller suitable for a switched mode power supply with a power switch are provided. An ON time of the power switch is recorded. An estimated OFF time is provided based on the ON time. The estimated OFF time is in positive correlation with the ON time. The power switch is turned ON after the elapse of the estimated OFF time.

### CROSS-REFERENCE TO RELATED APPLICATION

This application claims the priority benefits of U.S. provisional application Ser. No. 61/429,188, filed on Jan. 03, 2011. The entirety of the above-mentioned patent applications is hereby incorporated by reference herein and made a part of this specification.

### BACKGROUND

The present disclosure relates generally to switched-mode power supplies, especially to QR-similar power supplies.

Almost each electronic product needs a power supply to convert electric energy of power sources such as batteries or power grid lines into a power source specifically suitable to its own core circuit. Conversion efficiency, among other factors, is an important issue that circuit designers must concern.

Quadrature-resonance (QR) mode power supplies could reduce the switching loss of a power switch. The conversion efficiency of QR mode power supplies are, in theory and in practice, excellent in comparison with other power supplies, such that QR mode power supplies are welcome in the art, especially in high power applications.

FIG. 1 illustrates a conventional QR mode power supply 8. Converter 10 shows a boost topology. QR mode power controller 18 switches power switch 15 to control energization or de-energization of primary winding PRM. Feedback circuit 20 detects the voltage at output node OUT and generates feedback signal V_{FB} at feedback node FB of QR mode power controller 18.

FIG. 2 shows some waveforms of signals in FIG. 1, wherein, from top to bottom, gate signal V_{GATE} represents the voltage at node GATE; voltage signal V_{ZCD} represents the voltage at zero current detection node ZCD; current sense signal V_{CS} represents the voltage at current sense node CS; signal V_{CN} represents the voltage at connection node CN; and current signal I_{PRM} represents the current flowing through primary winding PRM.

QR mode power controller 18 controls ON time T_{ON} of power switch 15, meaning the time period when power switch 15 performs a short circuit, based on feedback signal V_{FB}. Off time T_{OFF}, when power switch 15 performs an open circuit, is controlled according to the detection at zero current detection node ZCD. For example, at the moment of zero current detection time t_{ZCD}, QR mode power controller 18 detects voltage signal V_{ZCD} drops across 0 volt, and this crossing is deemed as an indication that the de-energization of primary winding PRM and auxiliary winding AUX is completed. A delay time after zero current detection time t_{ZCD}, QR mode power controller 18 turns on power switch 15 and starts ON time T_{ON} of a following switch cycle.

What an ideal QR mode power controller 18 expects to achieve is that, when power switch 15 is turned ON, signal V_{CN} is locating at or around a valley to reduce the switching loss of power switch 15.

### SUMMARY

Embodiments of the present invention provide a control method suitable for a switched mode power supply with a power switch. An ON time of the power switch is recorded. An estimated OFF time is provided based on the ON time. The estimated OFF time is in positive correlation with the ON time. The power switch is turned ON after the elapse of the estimated OFF time.

Embodiments of the present invention provide a QR-similar power controller. A QR-similar timing generator asserts a QR-similar setting signal to turn on a power switch after an estimated OFF time when the power switch is switched from an ON state to an OFF state. The estimated OFF time is generated by the QR-similar timing generator based on an ON time of the power switch, and the estimated OFF time is in positive correlation with the ON time.

### BRIEF DESCRIPTION OF THE DRAWINGS

The invention can be more fully understood by the subsequent detailed description and examples with references made to the accompanying drawings, wherein:

FIG. 1 illustrates a conventional QR mode power supply;

FIG. 2 shows some waveforms of signals in FIG. 1;

FIG. 3 enlarges portions of signal V_{CN} and current signal and illustrates their relationships in timing;

FIG. 4 shows a QR-similar power supply according to embodiments of the invention;

FIG. 5 exemplifies internal circuitry of a QR-similar power controller;

FIG. 6A shows a clock timing generator;

FIG. 6B illustrates clock frequency f_{CYC-C} in connection with feedback signal V_{FB};

FIG. 7A shows a QR-similar timing generator;

FIG. 7B illustrates clock frequency f_{CYC-QRS} in connection with feedback signal V_{FB};

FIG. 8 illustrates clock frequency f_{CYC} in connection with feedback signal V_{FB};

FIG. 9 shows a delay device; and

FIG. 10 illustrates waveforms of signals in FIG. 5, FIG. 7A and FIG. 9.

### DETAILED DESCRIPTION

FIG. 3 enlarges portions of signal V_{CN} and current signal I_{PRM} and illustrates their relationships in timing.

As shown in FIG. 3, cycle time T_{CYC} is consisted of ON time T_{ON} and OFF time T_{OFF}, which has two parts: discharge time T_{DIS} and ring time T_{RNG}. Discharge time T_{DIS} refers to the time for primary winding PRM to de-energize completely, or the elapse time when current signal I_{PRM} decreases to 0 A from its maximum value. After the completion of the de-energization of primary winding PRM, primary winding PRM and the parasitic capacitor at connection node CN compose an LC resonance circuit, such that signal V_{CN} starts oscillating and dropping. A well-designed QR mode power controller shall turn ON a power switch after ring time T_{RNG} during which signal V_{CN} oscillates from a top to a valley.

It can be derived that, as for an ideal QR mode power supply, discharge time T_{DIS} is in proportion to ON time T_{ON} and ring time T_{RNG} is in proportional to an oscillation period of the parasitic LC resonance circuit. Accordingly, cycle time T_{CYC} could be presented by the following equation I.

$$\begin{matrix}{T}_{CYC} = {T}_{ON} + {T}_{OFF} \\ = {T}_{ON} + {T}_{DIS} + {T}_{RNG} \\ = {T}_{ON} + {K}_{1} * {T}_{ON} + {K}_{2} * sqrt ( {L}_{PRM} * {C}_{CN} ) ,\end{matrix} \qquad I$$

wherein, K₁ and K₂ are two constants, sqrt() represent the function of square root, L_{PRM} represents the inductance of primary winding PRM, C_{CN} represents the equivalent capacitance at node CN. If a power supply operates to have a cycle time T_{CYC} as shown in equation I, it operates substantially in QR mode.

In the art, zero current detection time t_{ZCD} is detected and a delay time is predetermined to decide the end of OFF time T_{OFF}. The actual discharge time T_{DIS} and ring time T_{RNG} are not detected or generated. Therefore, operation in QR mode is achieved probably instead of accurately.

An embodiment of this invention discloses a QR-similar power supply, which detects no zero current detection time t_{ZCD} and operates in QR mode with considerable accuracy.

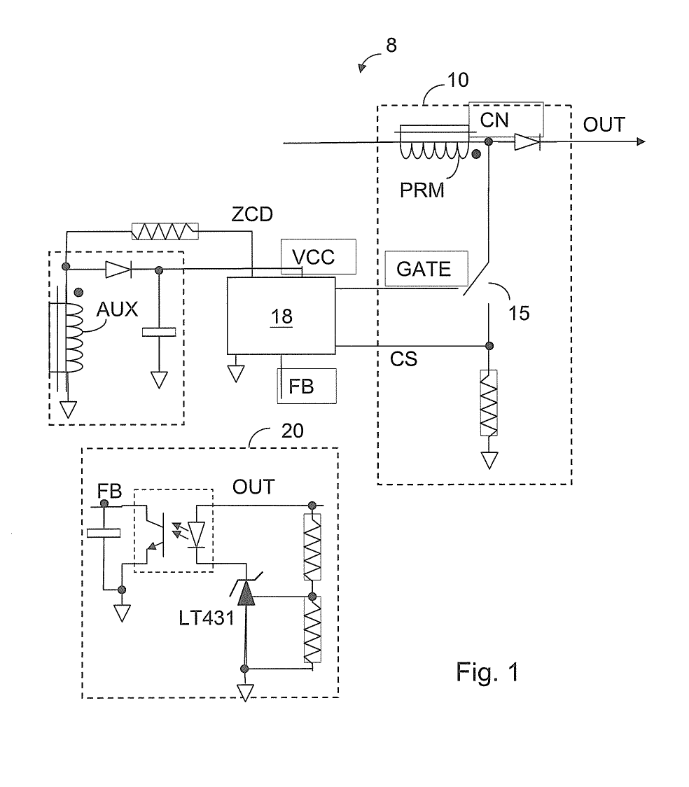

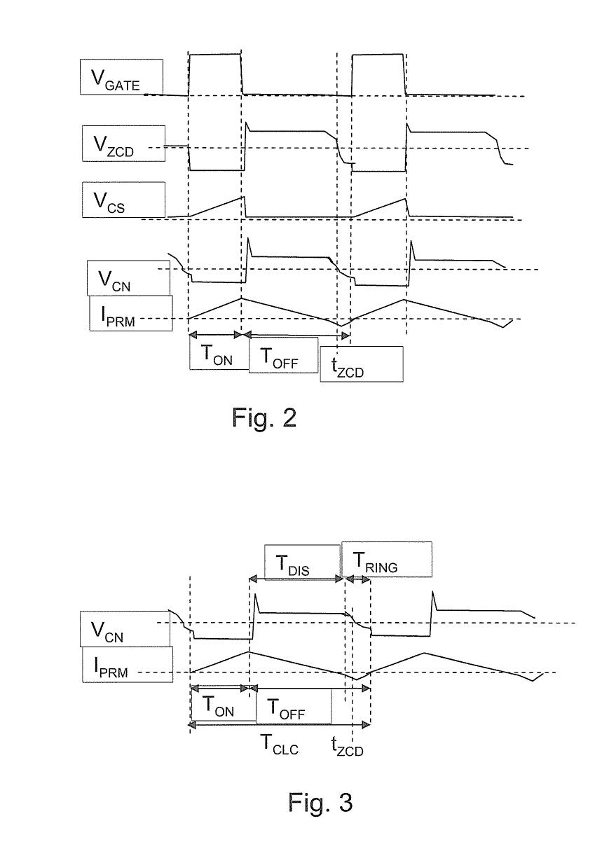

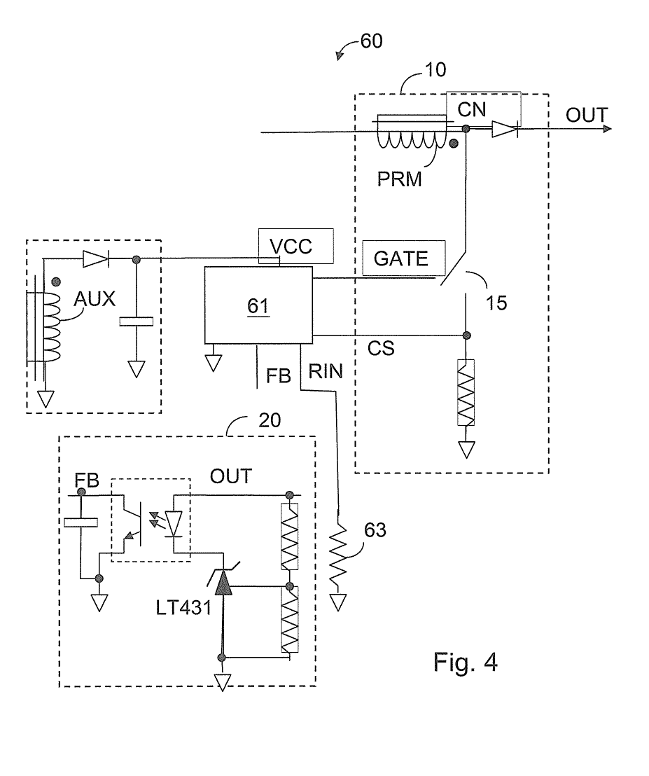

FIG. 4 shows a QR-similar power supply 60 according to embodiments of the invention, wherein those same or similar to FIG. 1 are comprehensible to those skilled in the art, and are not detailed for brevity. Unlike FIG. 1, QR-similar power supply 60 has QR-similar power controller 61 having no zero current detection node ZCD, but delay setting node RIN instead, connected to resistor 63. QR-similar power controller 61 could be formed on a monolithic chip with pins of VCC, GND, GATE, CS, RIN, and FB.

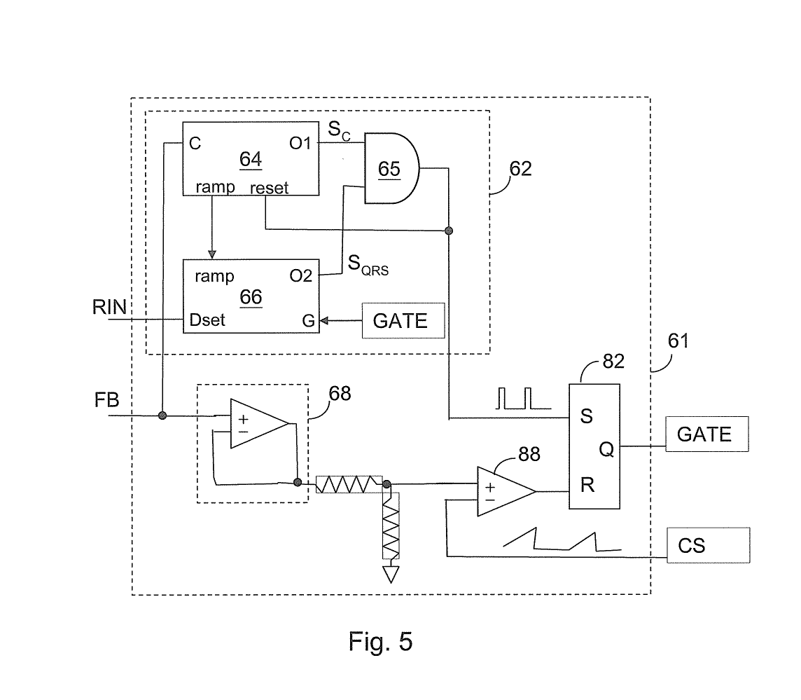

FIG. 5 exemplifies internal circuitry of QR-similar power controller 61. Feedback signal V_{FB} at feedback node FB substantially controls, via buffer 68, voltage-dividing resistors, and comparator 88, the peak voltage of current sense signal V_{CS} and ON time T_{ON} as well. Clock generator 62 generates pulse signal, periodically setting SR register 82 and determining the beginning of ON time T_{ON}, which equals to the ending of OFF time T_{OFF} in the previous switch cycle.

Clock generator 62 has QR-similar timing generator 66 and clock timing generator 64, whose outputs O1 and O2 both are connected to AND gate 65. Output of AND gate 65 is connected to not only S terminal of SR register 82, but also the reset node of clock timing generator 64. Because of the existence of AND gate 65, the later of asserted QR-similar setting signal S_{QRS} output from QR-similar timing generator 66 or asserted clock setting signal S_{C} output from clock timing generator 64 sets SR register 82 to turn ON power switch 15 and resets clock timing generator 64.

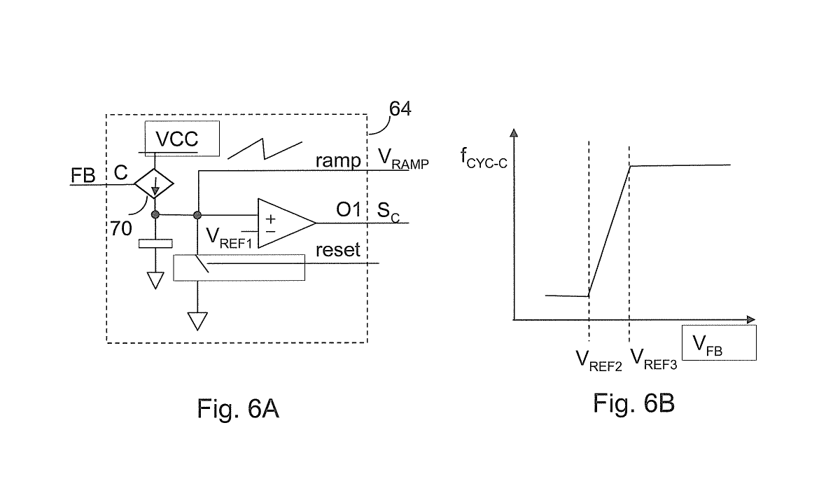

FIG. 6A shows clock timing generator 64. According to feedback signal V_{FB}, voltage-controlled current source 70 determines its output current and the slope of ramp signal V_{RAMP} as well. At the time when ramp signal V_{RAMP} exceed reference voltage V_{REF1}, a comparator asserts clock setting signal S_{C} at its output O1. The reset node of clock timing generator 64, if “1” in logic, renders the discharge of a capacitor and ramp signal V_{RAMP} is reset to be 0 volt.

If clock setting signal S_{C} were directly forwarded to the reset node in FIG. 6A, clock timing generator 64 becomes a clock generator, whose clock frequency f_{CYC-C} in connection with feedback signal V_{FB} is exemplified in FIG. 6B, where, if feedback voltage V_{FB} is lower than reference voltage V_{REF2}, clock frequency is substantially at a minimum; if feedback signal V_{FB}, exceeds reference voltage V_{REF3}, it is substantially at a maximum; and, if feedback signal V_{FB} is between reference voltages V_{REF2} and V_{REF3}, it varies linearly along with feedback signal V_{FB}.

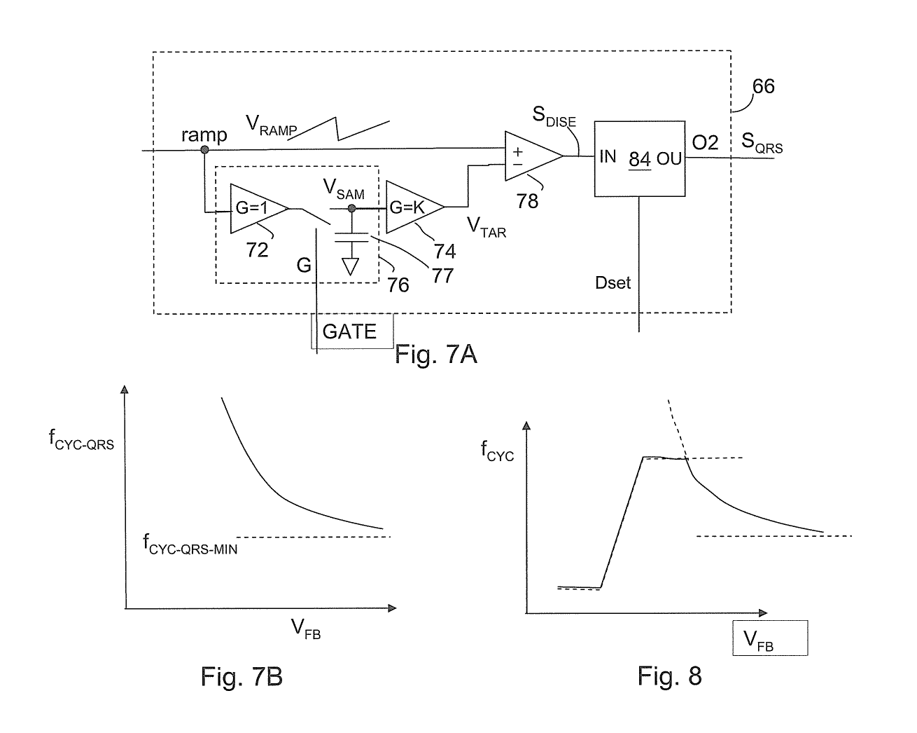

FIG. 7A shows QR-similar timing generator 66. The voltage gain of amplifier 72 is one, such that amplifier 72 duplicates ramp signal V_{RAMP} at its output. At the moment when gate signal V_{GATE} switch power switch 15 from an ON state to an OFF state, sample/hold circuit 76 samples ramp signal V_{RAMP} and keeps the record in capacitor 77 as sampled record V_{SAM}. In a way, sampled record V_{SAM} represents or records ON time T_{ON}. Amplifier 74, whose voltage gain is K, larger than 1, amplifies sampled record V_{SAM} to generate discharge target value V_{TAR} (=K*V_{SAM}). At the moment when ramp signal V_{RAMP} exceeds discharge target value V_{TAR}, comparator 78 asserts completion signal S_{DISE}. It takes ON time T_{ON} for ramp signal V_{RAMP} to ramp up from 0V to sampled record V_{SAM}. Accordingly, estimated discharge time T_{DISE} for ramp signal V_{RAMP} to ramp up from sampled record V_{SAM} to discharge target value V_{TAR} can be expressed by the following equation II.

$$\begin{matrix}{T}_{DISE} = ( {V}_{TAR} - {V}_{SAM} ) / {V}_{SAM} * {T}_{ON} \\ = ( K - 1 ) * {T}_{ON} .\end{matrix} \qquad II$$

Accordingly, the combination of sample/hold circuit 76, amplifier 74 and comparator 78 represents as a discharge time generator that asserts completion signal S_{DISE} to indicate the completion of de-energization after estimated discharge time T_{DISE}, which is in proportion to ON time T_{ON} as shown in equation II.

Delay device 84 provides delay time T_{DLY}, which could be determined by resistor 63 connected at delay setting node RIN. Delay time T_{DLY} after completion signal S_{DISE} is asserted, delay device 84 asserts QR-similar setting signal S_{QRS}.

If QR-similar setting signal S_{QRS} were directly forwarded to the reset node of clock timing generator 64, the combination of QR-similar timing generator 66 and clock timing generator 64 performs as another clock generator, whose clock frequency f_{CYC-QRS} in connection with feedback signal V_{FB} is exemplified in FIG. 7B. The higher feedback signal V_{FB}, the longer ON time T_{ON}, the longer estimated discharge time T_{DISE}, the slower clock frequency f_{CYC-QRS}. Cycle time T_{CYC-QRS}, the inverse of clock frequency f_{CYC-QRS}, can be expressed by the following equation III.

$$\begin{matrix}{T}_{CYC \text{-} QRS} = {T}_{ON} + {T}_{OFFE} \\ = {T}_{ON} + {T}_{DISE} + {T}_{DLY} \\ = {T}_{ON} + ( K - 1 ) * {T}_{ON} + {T}_{DLY}\end{matrix} \qquad III$$

Here in this embodiment, estimated OFF time T_{OFFE} provided is the summation of delay time T_{DLY} and estimated discharge time T_{DIS}, and is in positive correlation with ON time T_{ON}. In other words, the longer ON time T_{ON}, the longer estimated OFF time T_{OFFE}. As long as K and delay time T_{DLY} are properly designed, equation III will be equivalent to equation I, such that the timings for QR-similar timing generator 66 to switch ON or OFF a power switch will be substantially the same with those required for operating in ideal QR mode.

If needed, a device (no shown) might be provided to limit the minimum of clock frequency f_{CYC-QRS}. In other words, in one embodiment, clock frequency f_{CYC-QRS} cannot be lower than a predetermined minimum frequency f_{CYC-QRS-MIN}.

Because of the existence of AND gate 65, for a fixed feedback signal V_{FB}, clock generator 62 of FIG. 5 will provide clock frequency f_{CYC}, which is the less of clock frequency f_{CYC-QRS} in FIG. 7B or clock frequency f_{CYC-C} in FIG. 6B, and the result is demonstrated in FIG. 8. When feedback signal V_{FB} is relatively high, clock generator 62 provides timings similar with those required for operating in ideal QR mode. When feedback signal V_{FB} is relatively low, clock generator 62 provides clock frequency f_{CYC} substantially decreasing with the decrease of feedback signal V_{FB}, enhancing conversion efficiency for light load.

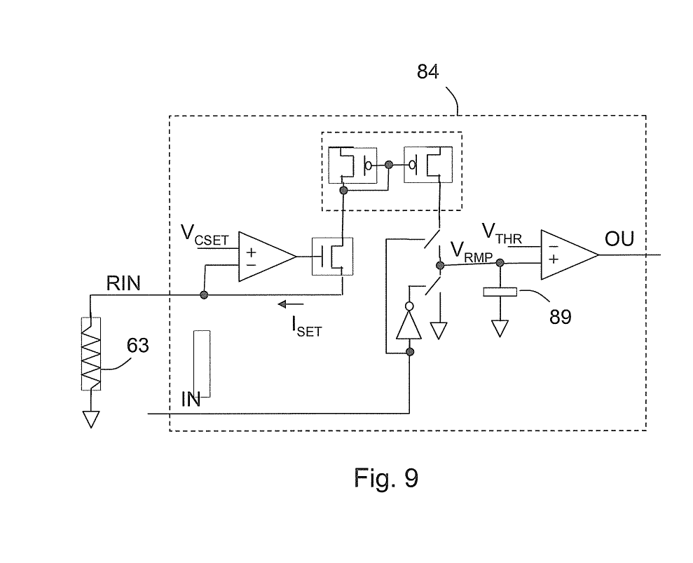

FIG. 9 illustrates delay device 84, whose IN node receive completion signal S_{DISE} to provide delay time T_{DLY}. In one embodiment, QR-similar power controller 61 is formed on a monolithic chip with delay setting pin RIN. Resistor 63 could be outside the monolithic chip and determines both current I_{SET} and delay time T_{DLY}. The operation and the theory of delay device 84 are comprehensible to persons skilled in the art and are not detailed for brevity.

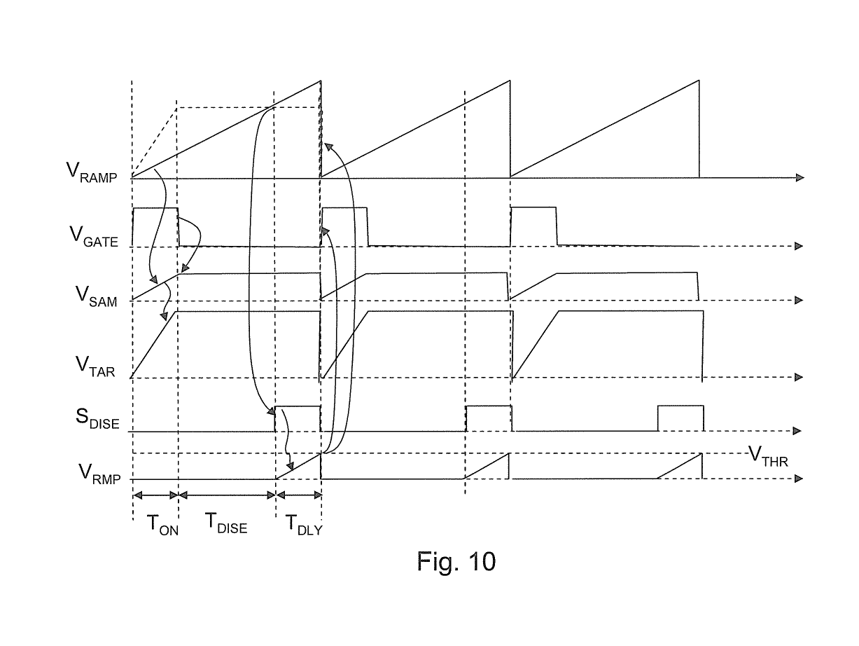

FIG. 10 illustrates waveforms of signals in FIG. 5, FIG. 7A and FIG. 9, where signal V_{RMP} is the voltage at capacitor 89; and V_{THR} is a predetermined voltage. The relationships between the signals in FIG. 10 can be derived from the previous teaching based on FIGS. 5, 7A and 9 by persons skilled in the art, such that they are not detailed here for brevity.

Although a booster power converter is shown as an embodiment of the invention, this invention is not limited to, but could be applied to buck converters, flyback converters and the like.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A control method suitable for a switched mode power supply with a power switch, the method comprising:
recording an ON time of the power switch;
providing an estimated OFF time based on the ON time, wherein the estimated OFF time is in positive correlation with the ON time; and
turning ON the power switch after the elapse of the estimated OFF time.

2. The control method as claimed in claim 1, wherein the step of recording the ON time comprises:
providing a ramp signal;
recording the ramp signal at the moment when the power switch is switched from an ON state to an OFF state to generate a sampled record.

3. The control method as claimed in claim 2, further comprising:
amplifying the sampled record to generate a discharge target value;
comparing the ramp signal with the discharge target value; and
asserting a completion signal when the ramp signal exceeds the discharge target value.

4. The control method as claimed in claim 2, comprising:
after the elapse of the estimated OFF time, asserting a first setting signal;
comparing the ramp signal with a reference voltage;
asserting a second setting signal if the ramp signal exceeds the reference voltage; and
turning on the power switch if both the first and second setting signals are asserted.

5. The control method as claimed in claim 1, wherein the step of providing the estimated OFF time comprises:
providing an estimated discharge time in proportion to the ON time;
providing a delay time; and
after the elapse of the delay and the estimated discharge time, turning ON the power switch.

6. The control method as claimed in claim 5, comprising:
asserting a completion signal after the elapse of the estimated discharge time;
the delay time after the completion signal is asserted, asserting a QR-similar setting signal to turn ON the power switch.

7. The control method as claimed in claim 1, comprising:
asserting a QR-similar setting signal after the estimated OFF time;
asserting a clock setting signal based on a feedback signal; and
when both the clock setting signal and the QR-similar setting signal are asserted, turning on the power switch.

8. A QR-similar power controller, comprising:
a QR-similar timing generator, for asserting a QR-similar setting signal to turn on a power switch after an estimated OFF time when the power switch is switched from an ON state to an OFF state;
wherein the estimated OFF time is generated by the QR-similar timing generator based on an ON time of the power switch, and the estimated OFF time is in positive correlation with the ON time.

9. The QR-similar power controller as claimed in claim 8, comprising:
a clock generator, comprising:
the QR-similar timing generator; and
a clock timing generator, for providing a clock setting signal;
wherein when both the clock setting signal and the QR-similar setting signal are asserted, the power switch is turned on.

10. The QR-similar power controller as claimed in claim 8, wherein the QR-similar timing generator comprises:
a discharge time generator, for asserting a completion signal after an estimated discharge time; and
a delay device for asserting the QR-similar setting signal a delay time after receiving the asserted completion signal;
wherein the estimated discharge time is in proportion to the ON time.

11. The QR-similar power controller as claimed in claim 8, wherein the QR-similar timing generator comprises a sample/hold circuit for sampling a ramp signal at the moment when the power switch is switched from an ON state to an OFF state to generate a sampled record.

12. The QR-similar power controller as claimed in claim 11, wherein the QR-similar timing generator comprises:
an amplifier to amplify the sampled record and generate a discharge target value.

13. The QR-similar power controller as claimed in claim 12, wherein the QR-similar timing generator comprises:
a comparator for comparing the ramp signal with the discharge target value to generate a completion signal.

14. The QR-similar power controller as claimed in claim 8, comprising:
a delay device for asserting the QR-similar setting signal a delay time after receiving an asserted completion signal;
wherein the QR-similar power controller is formed on a monolithic chip with a pin, through which the delay device is connected to a delay setting resistor.
